(19) United States
(12) Patent Application Publication
(10) Pub. No.: US 2011/0231562 A1
(43) Pub. Date: Sep. 22, 2011

(54) Method and Arrangements in a Communication Network

(76) Inventors: Johnny Karlsen, Jarfalla (SE); Christer Boberg, Tungelsta (SE); Anders Eriksson, Linkoping (SE); Per Willars, Vaxholm (SE)

(21) Appl. No.: 13/130,632

(22) PCT Filed: Nov. 24, 2008
(86) PCT No.: PCT/SE2008/051338

§ 371 Date: May 23, 2011

(51) Int. Cl. G06F 15/16

(52) U.S. Cl. 709/228; 709/227

(57) ABSTRACT

Methods executed in a server in a communication network are provided. The server handles messages for at least one client and/or application. The method includes identifying deterioration in a connectivity or reachability between the server and the at least one client and/or application; and transmitting a re-establishment message to the at least one client and/or application. The message makes or enables the at least one client and/or application reestablish the connectivity or reachability. Related devices are also provided herein.

### TECHNICAL FIELD

The present invention relates to methods and arrangements relating to connectivity or reachability in a communication network.

### BACKGROUND

When there is connectivity or reachability between a server and a client it is often advantageous if the connectivity or reachability can be maintained, e.g. so that the server can send messages to the client at any time. Such a connectivity or reachability may be established so that the client can be provided with services and applications transmitted to the client by or via the server.

One solution for maintaining connectivity or reachability from a server to a client through for example a firewall (FW) is to continuously send keep-alive messages on the connection between the server and the client in order to keep the pinhole state of the firewall open. The connection or path through a firewall is often called pinhole. The firewall may have Network Address Translation (NAT) functionality.

The keep-alive message must be sent frequently enough not to let the pinhole open state in the firewall expire. The frequency with which the keep-alive message must be sent depends on the transport protocol used and is also dependent on the settings of the firewall. The protocol User Datagram Protocol (UDP) generally needs a relatively high send-frequency, in the region of multiple times per minute, and the Transmission Control Protocol (TCP) can function with a lower send-frequency, in the region of multiple times per hour.

If for some reason the pinhole open state in the firewall expires, e.g. while the firewall is restarted or for some other reason, the server can no longer reach the client. There is no guarantee, or is even likely, that the client will in any way be informed that the connectivity or reachability path towards, or with, the server has been terminated. This situation lasts until the client once again initiates a connectivity or reachability path towards, or with, the server.

One solution to handle this situation is to introduce keep-alive messages with a frequency high enough to make sure that potential outages of the connectivity or reachability will be short enough not to adversely affect the perceived Quality of Service (QoS) of the application or service provided to the client. Often keep-alive messages are sent with an interval of 30 seconds between each message.

One area where the method of sending keep-alive messages is used to maintain reachability to clients connected to a server via a firewall is when a service within, or using, IP Multimedia Subsystem (IMS) or Session Initiation Protocol (SIP) is offered to mobile clients or terminals by a system outside of the network of the mobile access operator. This form of a standalone IMS or SIP system is relevant when enabling services that are delivered by the use of IMS and/or SIP to reach users not only in those access networks where the operator has deployed IMS or SIP, but also to reach the users in access networks with no IMS or SIP infrastructure. In this latter case, the IMS or SIP server is typically on the Internet, and a TCP connection is setup when the client registers to the IMS or SIP server.

Examples of Problems with Existing Solutions

On the fixed Internet with high bandwidth and extremely low cost for each sent package, e.g. flat rate, the above solution with sending keep-alive messages often functions in a satisfactory way. It adds a very small noise to the general traffic flow already present.

However, when the client is a mobile client on a cellular network the situation is quite different.

The additional cost for each sent packet, e.g. a keep-alive message, is no longer zero, since flat rate is not the common case. There is also a high battery and radio resource penalty in sending small packets spaced in time since the radio stays active for a duration longer than it takes to transmit the small packet. Using the above example with sending a keep-alive message every 30 seconds would often mean that the radio would remain in an active state more or less continuously.

As described above, changing to the Transmission Control Protocol (TCP) as the transport protocol will make it possible to use much lower transmitting frequency for the keep-alive messages. However, one problem is that the experienced QoS when there are problems, e.g. deterioration or interruption of the connectivity or reachability between server and client, will be increasingly lower with lowered transmitting frequency for the keep-alive messages. One reason for problems with the connectivity or reachability between server and client is when the firewall behaves in an unexpected way and the pinhole open state expires or terminates. With the expression “the firewall behaves in an unexpected way” is e.g. meant that the configuration of the firewall changes in regards to what is required to keep the pinhole in an open state. Such configuration may e.g. relate to how long a pinhole may be open and which signalling that is required to keep the pinhole in an open state. If the server is not informed about such changes, the firewall will behave in an unexpected way from a server point of view and the pinhole open state may unexpectedly expire or terminate.

It is an aim to provide a method and an arrangement that obviates or at least reduces some or all of the drawbacks connected with the background art.

### SUMMARY

It is an object of the present invention to address the problems or drawbacks outlined above. This object and as well others may be obtained by providing methods and arrangements according to the independent claims attached below.

A client as mentioned herein may be present on a terminal, e.g. a mobile terminal. There may be several clients on or in one terminal. The client may comprise at least one platform, e.g. a SIP and/or an IMS platform and at least one application.

In a general form it is suggested to send a re-establishment message to a client when or after that a deterioration in a connectivity or reachability between the client and a server has been detected, this server may be called a first server. The deterioration may e.g. be an interruption of the connectivity or reachability. The re-establishment message makes or enables the client to re-establish the connectivity or reachability with the first server. The re-establishment message may be sent from the first server, but it may also be sent from another server, e.g. an additional server monitoring the connectivity or reachability between the client and the first server. The server sending the re-establishment message to the client is provided with, or has access to, address information of the client. The address information of the client may include the MSISDN address of the client or terminal and a port identifier, e.g. a port number, of an available communication port of the terminal. Several clients may be comprised on, or in, a terminal and the MSISDN number relates to the terminal as a whole. A certain communication port of the terminal is or can be related or connected to a certain client and/or a certain application. The expression “client communication port” means that a communication port of the terminal is related or connected to a certain client and/or a certain application, e.g. while the client has registered itself for listening to this communication port.

By having the MSISDN number of a terminal and a port number or identifier, any client and/or application on a terminal can be addressed or reached.

According to one aspect there is provided a first method executed in a server in a communication network. The server may handle messages for at least one client and/or application.

The first method may comprise to identify a deterioration in a connectivity or reachability between the server and the at least one client and/or application.

The first method may further comprise to transmit a re-establishment message to the at least one client and/or application. The re-establishment message is adapted or contains such information so as to make or enable the at least one client and/or application to re-establish the connectivity or reachability. The re-establishment message may also be empty, i.e. contain no information, e.g. contain no information in the body of the re-establishment message.

The first method may optionally have the following further characteristics:

In one embodiment the connectivity or reachability is established via or through a pinhole in a firewall.

In another embodiment the deterioration is a termination of an open state of said pinhole.

In a further embodiment the deterioration is an interruption of said connectivity or reachability.

In yet a further embodiment the deterioration is identified by said server.

In another embodiment the re-establishment message is transmitted from the server to the at least one client and/or application.

In a further embodiment the connectivity or reachability is re-established to the state it had before the deterioration.

In another embodiment the measure of identifying a deterioration in a connectivity or reachability may be preceded by the step of establishing a connectivity or reachability between the at least one client and/or application, and said server.

The measure of identifying a deterioration in a connectivity or reachability may further be preceded by the step of registering, or making available, a terminal address and a client communication port identifier of the at least one client at or for the server.

In a further embodiment the terminal address is the Mobile Subscriber Integrated Services Digital Network Number (MSISDN) of a terminal of the at least one client, and the client communication port identifier relates to a client communication port, being e.g. a WAP Push port, of the at least one client and/or application.

According to another aspect there is provided a server arrangement in a server for handling messages for at least one client and/or application. The server arrangement may comprise an identifying element for identifying a deterioration in a connectivity or reachability between the server and the at least one client and/or application.

The server arrangement may further comprise a transmitting element for transmitting a re-establishment message to the at least one client and/or application. Whereby the re-establishment message is adapted to make or enable the at least one client and/or application to re-establish the connectivity or reachability.

The server arrangement may optionally have the following further characteristics:

In one embodiment there is provided a server arrangement wherein the connectivity or reachability is established via or through a pinhole in a firewall.

In another embodiment there is provided a server arrangement wherein said deterioration is a termination of an open state of said pinhole.

In a further embodiment there is provided a server arrangement wherein the identifying element is adapted to identify an interruption in the connectivity or reachability.

In yet another embodiment there is provided a server arrangement wherein the transmitting element is adapted to transmit the re-establishment message from the server to the at least one client and/or application.

In yet a further embodiment there is provided a server arrangement wherein the transmitting element is adapted to transmit a re-establishment message that makes or enables the at least one client and/or application to re-establish the connectivity or reachability to the state it had before the deterioration.

In another embodiment there is provided a server arrangement that may comprise an establishing element that is adapted to establish a connectivity or reachability between the at least one client, and/or application, and the server. Further the server arrangement may comprise a registering element for registering, or making available, a terminal address and a client communication port identifier of the at least one client and/or application at or for the server.

In a further embodiment there is provided a server arrangement wherein the registering element is adapted to retrieve or receive the terminal address and the client communication port identifier from the at least one client and/or from a database.

In yet another embodiment there is provided a server arrangement wherein the terminal address is the Mobile Subscriber Integrated Services Digital Network Number of the terminal of the at least one client. Further the client communication port identifier relates to a client communication port, being e.g. a WAP Push port, of the at least one client and/or application.

According to a further aspect there is provided a second method executed in a client and/or application in a communication network. The client and/or application may be adapted to handle connectivity or reachability with or towards at least one server. The second method may comprise the measure of establishing connectivity or reachability between the client, and/or application, and the at least one server. The second method may further comprise the measure of transmitting a registration message to the server. The registration message may comprise a client communication port identifier and optionally a terminal address, of the client and/or application.

The second method may optionally have the following further characteristics:

In one embodiment the connectivity or reachability is established via or through a pinhole in a firewall.

In a further embodiment the deterioration is a termination of an open state of the pinhole.

In another embodiment the second method may comprise the step that the client and/or application receives a re-establishment message enabling or making the client and/or application to re-establish the connectivity or reachability with or towards the at least one server.

In yet a further embodiment the second method may comprise the step that the client and/or application receives the re-establishment message from the at least one server or from an additional server.

In yet a further embodiment the second method may comprise the step that the client, and/or application, registers itself for listening on or to an available communication port, e.g. a WAP-PUSH port, of the terminal on which said client, and/or application, resides. The step that the client, and/or application, registers itself for listening may be performed before the step of establishing connectivity or reachability.

In yet another embodiment the second method may comprise that the client comprises a platform, e.g. a SIP and/or IMS platform. The platform may be participating in the steps of establishing, transmitting, receiving and registering described above.

According to yet another aspect there is provided a client arrangement in a terminal in a communication network. The terminal may comprise at least one client and may be adapted to handle connectivity or reachability with or towards at least one server. The client arrangement may comprise a client establishing element adapted for establishing connectivity or reachability between a client, and/or application, and the at least one server. The client arrangement may further comprise a client transmitting element adapted for transmitting a registration message to the at least one server. The registration message may comprise a client communication port identifier and optionally a terminal address, of said client and/or application.

The client arrangement may optionally have the following further characteristics:

In one embodiment there is provided a client arrangement wherein the connectivity or reachability is established via or through a pinhole in a firewall.

In another embodiment there is provided a client arrangement wherein the deterioration is a termination of an open state of the pinhole.

In a further embodiment there is provided a client arrangement comprising a client receiving element that is adapted for receiving a re-establishment message. The re-establishment message is adapted for enabling or making the client to re-establish the connectivity or reachability with or towards the at least one server.

In yet another embodiment there is provided a client arrangement wherein the client receiving element is adapted to receive the re-establishment message from the at least one server or from an additional server.

In yet a further embodiment there is provided a client arrangement comprising a client registering element that is adapted so that the client, and/or application, can register itself for listening on or to an available communication port, e.g. a WAP-PUSH port, of the terminal on which the client and/or application resides.

In another embodiment there is provided a client arrangement wherein at least one of the client elements; client establishing element, client transmitting element, client receiving element and client registering element, is comprised in or on a platform, e.g. a SIP and/or an IMS platform, of or in the client.

One advantage of the methods and/or arrangements, in any of its forms or embodiments, is that frequent sending of keep-alive messages is avoided. Further, this is achieved without affecting the perceived QoS of the system, service or application. Yet further may the re-establishment procedure be completely contained, or executed completely, between the client and the first proxy node of the first server. The other end-point of the first server may be completely unaware or uninformed about the re-establishment procedure.

A further advantage is that it is enabled a robust operation of a server or system, e.g. an IMS/SIP or SIP server or system, which is located on the outside of a firewall of an access network. It may be that the access network is lacking the infrastructure of the server or system, e.g. a IMS/SIP or SIP infrastructure.

Further possible features and benefits of the present invention will be explained in the detailed description below.

### BRIEF DESCRIPTION OF THE DRAWINGS

The invention will now be described by way of non limiting exemplary embodiments and with reference to the accompanying drawings in which:

FIG. 1a schematically shows one example of a network topology in which the present methods and arrangements may be used, and elements of said methods and arrangements,

FIG. 1b schematically shows another example of a network topology in which the present methods and arrangements may be used, and elements of said methods and arrangements,

FIG. 2 schematically shows signalling and messages sent in one embodiment,

FIG. 3 schematically shows one embodiment of the server arrangement 300,

FIG. 4 schematically shows one embodiment of a registration message 400,

FIG. 5 schematically shows one embodiment of a re-establishment message 500,

FIG. 6 schematically shows a terminal, a client and one embodiment of the client arrangement 610.

### DETAILED DESCRIPTION

Before the methods and arrangements described herein are described more in detail, it is to be understood that these methods and arrangements are not limited to the particular component parts of the devices described or process steps of the methods described, as such devices and methods may vary. It is also to be understood that the terminology used herein is for purposes of describing particular embodiments only, and is not intended to be limiting. It must be noted that, as used in the specification and the appended claims, the singular forms “a,” “an” and “the” also include plural referents unless the context clearly dictates otherwise. Thus, for example, reference to “an element” includes more than one such element, and the like.

Some abbreviations:

Serving Call Session Control Function (S-CSCF)

Proxy Call Session Control Function (P-CSCF)

Mobile Subscriber Integrated Services Digital Network Number (MSISDN)

Session Initiation Protocol (SIP)

IP Multimedia Subsystem (IMS)

Internet Protocol (IP)

Transmission Control Protocol (TCP)

Transport Layer Security (TLS)

Home Subscriber Server (HSS)

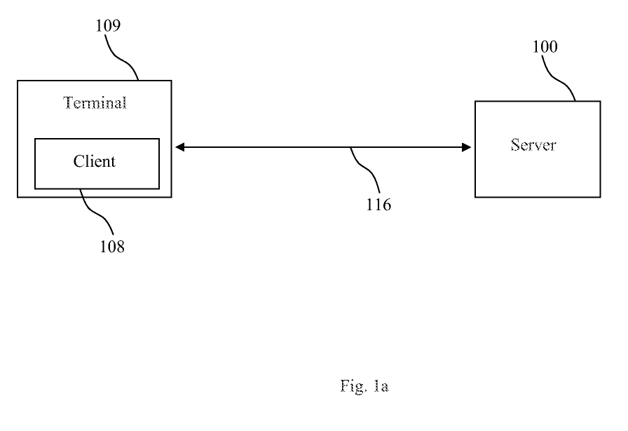

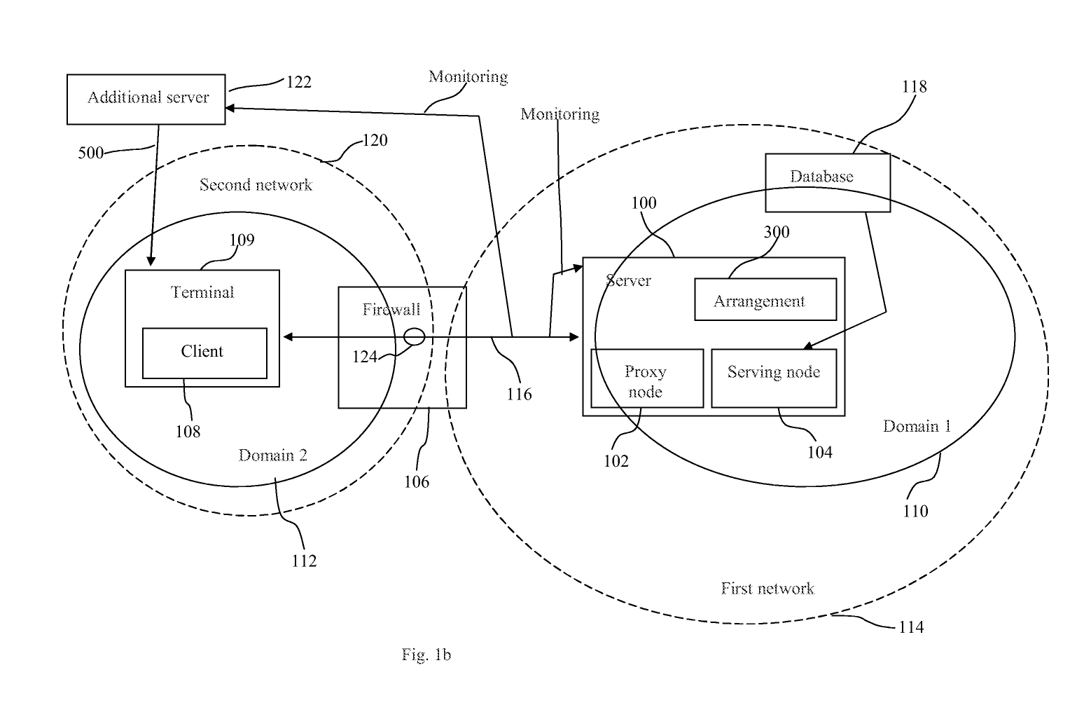

A general form is illustrated in FIG. 1a. A connectivity or reachability 116 between a server 100 and a client 108, e.g. residing in or on a terminal 109, may be interrupted or deteriorated for some reason and the methods and arrangements described can be used to re-establish said connectivity or reachability 116. One part of the re-establishing is that the server 100 transmits a re-establishment message 500 to the client 108. The re-establishment message 500 enables or makes the client 108 to re-establish the interrupted or deteriorated connectivity or reachability 116. The re-establishment message 500 may be sent using a different type of communication than of the connectivity or reachability 116. To be able to transmit the re-establishment message 500 the server 100 is provided with address information about the client 108. This address information may be transmitted from the client 108 to the server 100 but may also, at least in part, be provided to the server in some other way, e.g. by storing address information in a database connected to the server 100.

FIG. 1b illustrates a more detailed embodiment or form and will now be briefly described. FIG. 1b also includes optional elements, or elements from different embodiments, e.g. the additional server 122 and the database 118. The server 100 may include or comprise a proxy node 102 and a serving node 104. The server 100 may be a Call Session Control Function (CSCF) server, the proxy node 102 may be a Proxy-CSCF and the serving node 104 may be a Serving-CSCF. The firewall 106 may comprise a pinhole 124 and Network Address Translation (NAT) functionality. Domain 1 110 may be an IMS domain, domain 2 112 may be an operator domain, e.g. the network of a mobile access operator. The client 108 comprises a terminal 109 which may be a mobile terminal, the first network 114 may be the internet, the second network 120 may be a cellular network, e.g. of a mobile access operator. The connectivity or reachability 116 may e.g. be of the TCP or TLS type. The server 100 may comprise an arrangement 300 having among other parts a registering element 306 adapted to retrieve or receive the terminal address 620, e.g. a MSISDN, and/or the client communication port 622 from said client 108.

The registering element 306 may as well be adapted to retrieve the terminal address from a database 118, e.g. a user profile database such as an HSS database. The terminal address may e.g. be retrieved from a service profile.

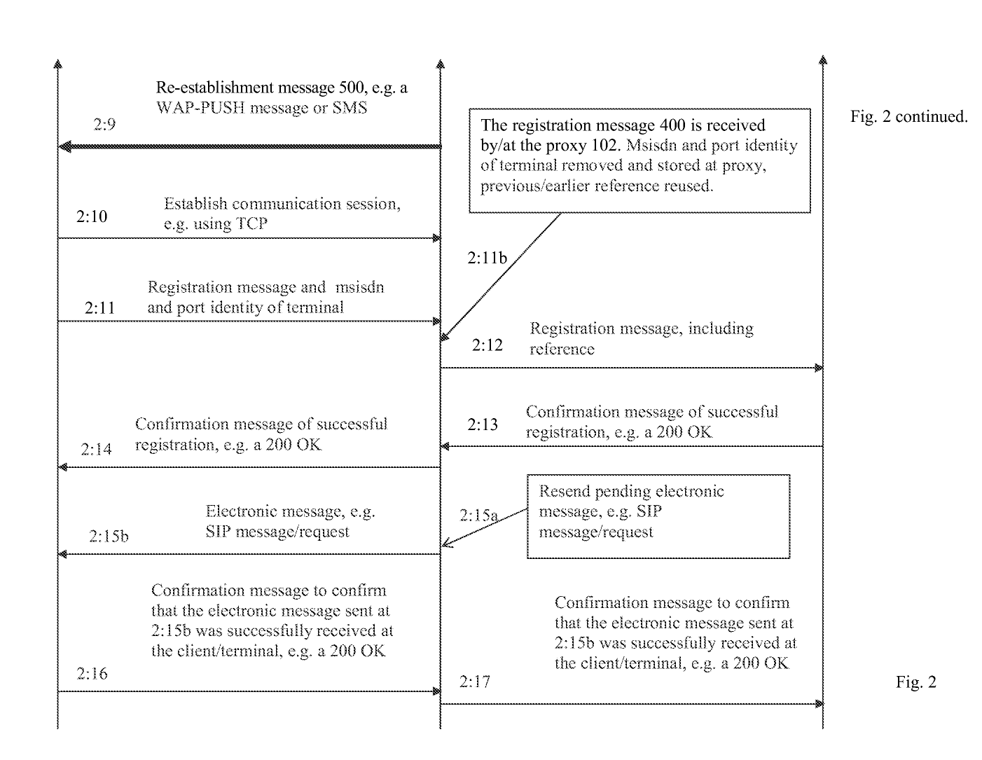

In FIG. 3 one embodiment of a server arrangement 300 in a server 100 is schematically shown. The server arrangement 300 may comprise an identifying element 302, a

transmitting element 304, a registering element 306, a

retrieving element 308 and an establishing element 310.

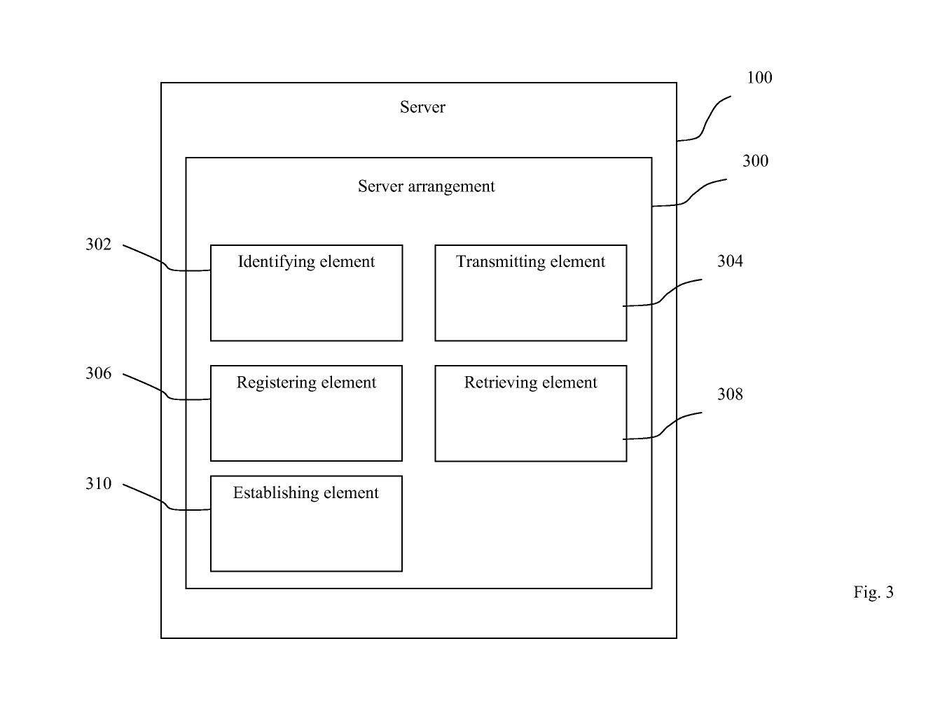

In FIG. 4 one embodiment of a registration message 400 is schematically shown. The registration message 400 may comprise address and port information 402 of the client 108 and terminal 109, e.g. msisdn of the terminal/client and a client communication port identifier 624. The communication port identifier 624 may e.g. be a communication port number 624. The communication port may e.g. be a WAP-Push port.

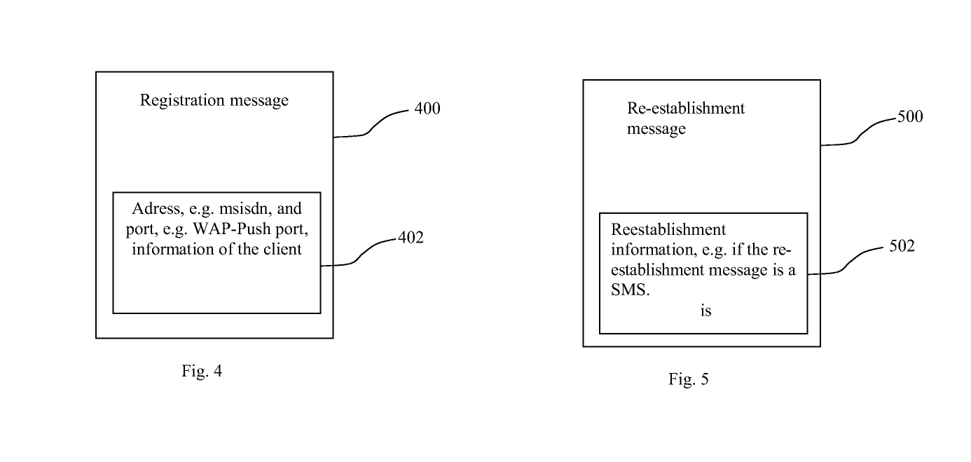

In FIG. 5 one embodiment of a re-establishment message 500 is schematically shown. The re-establishment message 500 may comprise reestablishment information 502. If the re-establishment message 500 is an SMS it could e.g. be suitable that the re-establishment message 500 comprises reestablishment information 502.

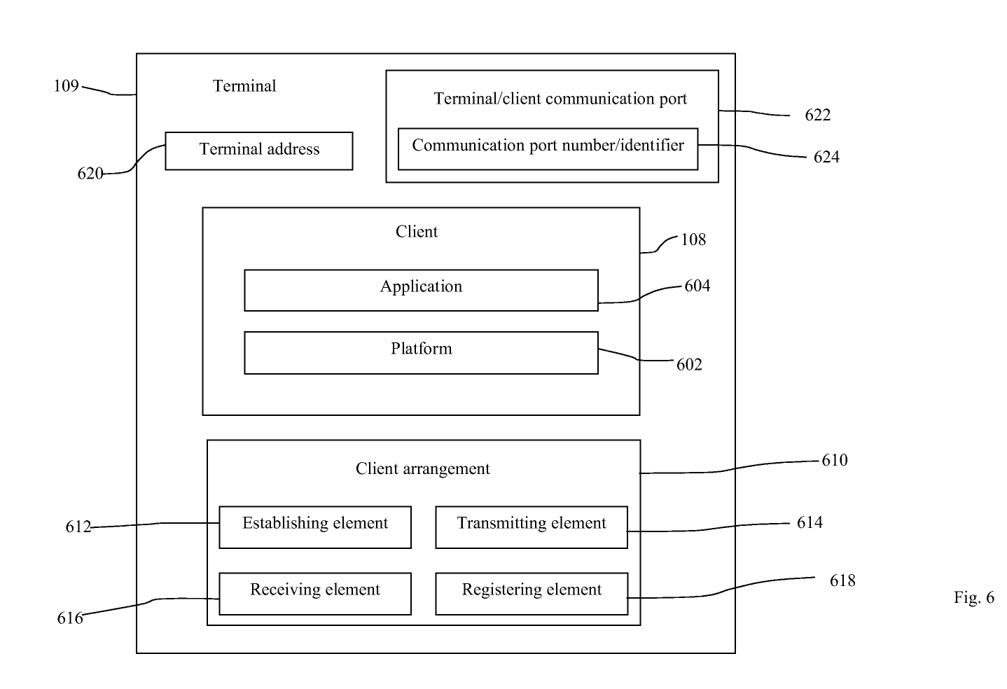

In FIG. 6 one embodiment of a terminal 109 is schematically shown. The terminal 109 may comprise at least one client 108, a terminal address 620 and at least one terminal/client communication port 622 having a communication port number or identifier 624. The client 108 may comprise at least one application 604 and at least one platform 602. The platform 602 may comprise a client arrangement 610 comprising at least one of a client establishing element 612, a client transmitting element 614, a client receiving element 616 and a client registering element 618.

In the following references will be made to all figures. In one embodiment WAP-PUSH is used for re-establishing the connectivity between the server 100 and the client 108. The server 100 may e.g. be a SIP server, in case IMS is implemented on the server 100 said server 100 may comprise a P-CSCF node.

If the first network 114 is a cellular network, e.g. a cellular Internet network, where it is not suitable to send keep-alive messages with a high frequency, WAP-PUSH is often utilised and can be used for re-establishing the connectivity from the server 100 to the client 108. If the first network 114 is a fixed network, e.g. a fixed Internet network, WAP-PUSH is often not present but keep-alive messages may be sent with a high frequency.

During initial establishment of the connectivity or reachability path from the client 108 to the server 100, the client 108 reports to the server the number of the WAP-PUSH port which is currently available at/in the terminal, and also or in parallel starts listening to this port for any server initiated connectivity or reachability.

The WAP-PUSH port number may be sent to the server 100 in the SIP REGISTER request in a new header named for example “Reestablish”. Which method that is used for sending the msisdn:port number that the SIP/IMS platform 602 of the client listens to is not critical. In this embodiment a new header is chosen to convey this information, but it can also be placed in the body or in an augmented, existing, header, for example using a feature tag.

The description in the following is based on using TCP for the transport or connectivity or reachability between the client and the server but this is just one example. Another protocol that may be used is e.g. TLS, this protocol has similar transport characteristics as TCP but the information is encrypted and the terminating point is authenticated to achieve a secure tunnel with a known endpoint.

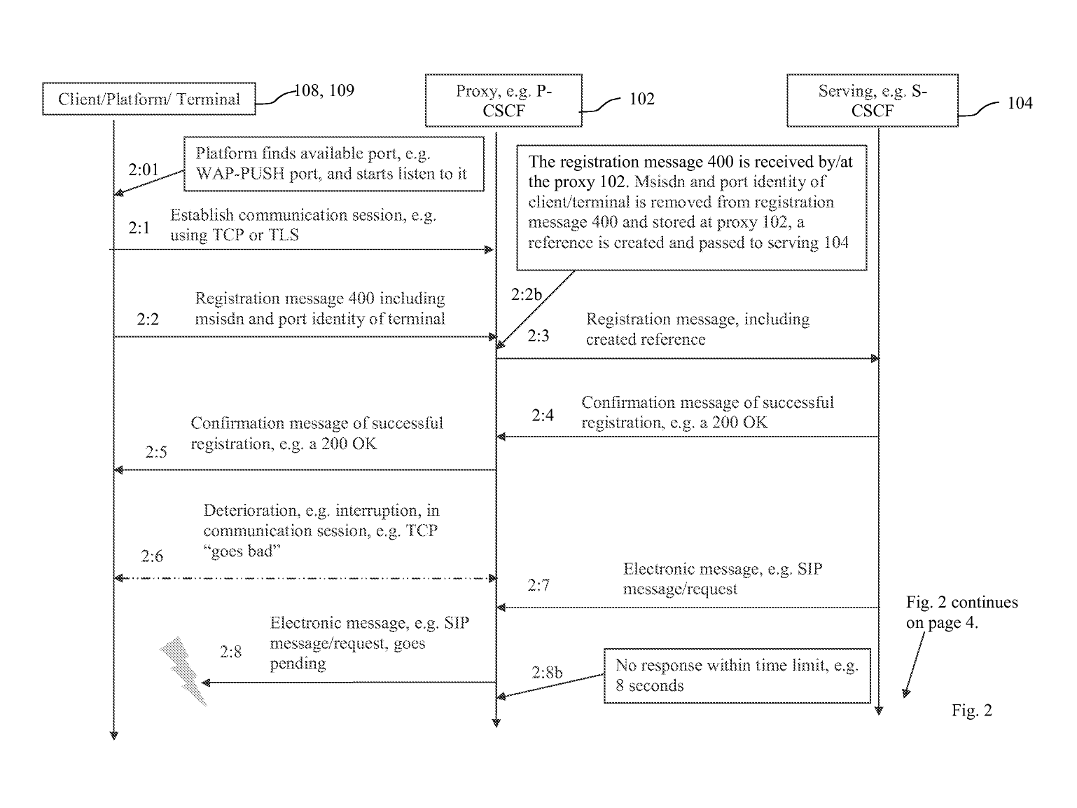

In the following an embodiment will be described, mainly referring to FIG. 2, where the server 100 supports IMS, i.e. IMS is implemented on the server 100. However, the method and arrangement are equally suited to be used in the case that the server 100 only supports SIP. The method has been described by dividing the different actions and occurrences in steps 1 to 8, but this is just one way of arranging the actions and occurrences in this embodiment. It would e.g. also be possible to describe each action and occurrence 2:01-2:17 separately, each action and occurrence being described in a separate paragraph.

1. The SIP/IMS platform 602 of the client 108 will register itself for listening on or to a currently available WAP-PUSH port of the terminal, shown at 2:01. The SIP/IMS platform 602 of the client establishes a TCP connection to the proxy node 102, here a P-CSCF, shown at 2:1. The SIP/IMS platform 602 of the client uses the TCP to make a registration, e.g. to send a registration message 400, towards the serving node 104, here an S-CSCF, via the proxy node 102. The registration message 400 contains address information 402 of the client, here in the form of the new header “Reestablish”. The format of this header is an MSISDN number and the local WAP-PUSH port number in the form “msidn:port”. A first part of the registration towards the serving node 104 is shown at 2:2.

2. The registration message 400 is received by/at the proxy node 102. The new header “Reestablish” is removed from the registration message 400 and the data from this header is stored at the proxy node 102 together with contact information for the client. This is shown at 2:2b. At 2:3 the registration message 400 is passed on to the serving node 104 together with the specific P-CSCF contact information. A response is received from the serving node 104 and passed on to the SIP/IMS platform 602 of the client, shown at 2:4 and 2:5. The proxy node's 102, here P-CSCF, contact information may comprise an internal reference in the P-CSCF used to point at the connection/connectivity of a specific client and may also comprise the P-CSCF identity. These two pieces of information may be used by the serving 104, here an S-CSCF, to address a specific client.

3. The REGISTER response sent at 2:5 is received by the SIP/IMS platform 602 of the client 108.

3b. At some point in time, illustrated at 2:6, the persistent TCP will have lost its state and can no longer be used by the server 100 to communicate with the client 108. Both endpoints, the client 108, and the proxy node 102 or P-CSCF are unaware of this situation.

4. A message/request comes in from the serving node 104 to the proxy node 102, this is illustrated at 2:7. This message/request is using the specific P-CSCF contact information previously saved at the serving node 104. The proxy node 102 looks up the specific TCP session or connection to be used, and passes on the request to be sent to the client 108. The message/request may e.g. be a pager mode message or a message within an instant messaging (IM) service, e.g. a chat message. At 2:8 it is illustrated that the message/request goes pending since the connectivity or reachability between server and client is not functioning.

5. At 2:8b it is illustrated that no response, e.g. a 200 OK, is received within a given time, in this case 8 seconds. Alternatively the proxy node 102 is notified in some other way about that the TCP session is no longer functional, e.g through a TCP RST (TCP Reset) message ? or state ?) indicating this. Once the proxy node 102 has been notified about, or has in any other way realised, the non-functional TCP session, it looks up the WAP-PUSH information for this client or contact and sends a re-establishment message 500 to the client 108 using the WAP-PUSH information, illustrated at 2:9. Alternatively the re-establishment message 500 may be sent in the form of an SMS containing the information that is necessary to enable or make the client 108 to re-establish the connectivity or reachability with the server 100.

6. The client 108 and/or terminal 109 receives the re-establishment message 500, e.g. a WAP-PUSH message, which is dispatched to the SIP/IMS platform 602 indicated by the port number. There could be multiple SIP/IMS platform 602s in the client 108/terminal 109 and each will listen to a specific port. The SIP/IMS platform 602 receives the re-establishment message 500, e.g. a WAP-PUSH, and establishes a new connectivity or reachability, e.g. using TCP or TLS, and sends a new registration message 400 in the same way as described in paragraph/heading 1., illustrated at 2:10, 2:11.

7. When the new registration message 400 enters the proxy node 102, here a P-CSCF, for this user or client, the earlier assigned specific contact information will be re-assigned to the new connection/connectivity or reachability, illustrated at 2:11b. This re-assignment will only take place if the contact information, source IP address, and call-id are the same as in an already existing registration. If this is not the case, the new registration message 400 will be treated as a new registration. The registration will be passed on to the serving node 104, here a S-CSCF, illustrated at 2:12. The S-CSCF will not see any difference between this registration and a regular re-registration, given that the condition above is fulfilled. Re-using the earlier existing contact information means that a currently pending request is still valid. Transmissions 2:13, 2:14 correspond to transmissions 2:4, 2:5.

8. The proxy node 102, here a P-CSCF, sends out the pending request on the new connectivity or reachability, e.g. of the TCP or TLS type, and receives a response which can be passed on to the S-CSCF 104. These transmissions are illustrated at 2:15a, 2:15b for the pending request and 2:16, 2:17 for the response.

The above description is for a non-INVITE transaction.

In case of a SIP INVITE transaction, the flow changes with respect to the “200 OK” message, this is in many cases user interaction dependent, so instead a 100 TRYING message or 180 RINGING message should be expected. Neither is the potential timer X needed since there is no 64*T1 timeout on a SIP INVITE.

Although particular embodiments have been disclosed herein in detail, this has been done by way of example for purposes of illustration only, and is not intended to be limiting with respect to the scope of the appended claims that follow. In particular, it is contemplated by the inventor that various substitutions, alterations, and modifications may be made to the invention without departing from the spirit and scope of the invention as defined by the following claims.

1. A method, executed in a server in a communication network, the server handling messages for at least one client and/or application, the method comprising:
identifying a deterioration in a connectivity or reachability between the server and the at least one client and/or application; and
transmitting a re-establishment message to the at least one client and/or application, the message making or enabling the at least one client and/or application re-establish the connectivity or reachability

2. The method of claim 1, wherein the connectivity or reachability is established via or through a pinhole in a firewall.

3. The method of claim 2, wherein the deterioration is a termination of an open state of the pinhole.

4. The method of claim 1, wherein the deterioration is an interruption of the connectivity or reachability.

5. The method of claim 1, wherein the deterioration is identified by the server.

6. The method of claim 1, further comprising transmitting the re-establishment message from the server to the at least one client and/or application.

7. The method of claim 1, wherein the connectivity or reachability is re-established to a state it had before the deterioration.

8. The method of claim 1, wherein identifying a deterioration in a connectivity or reachability is preceded by:
establishing a connectivity or reachability between the at least one client, and/or application and the server, and
registering, or making available, a terminal address and a client communication port identifier of the at least one client at or for the server.

9. The method of claim 8:
wherein the terminal address is the Mobile Subscriber Integrated Services Digital Network Number (MSISDN) of a terminal of the at least one client; and
wherein the client communication port identifier relates to a client communication port being a WAP Push port of the at least one client and/or application.

10. A server arrangement in a server for handling messages for at least one client and/or application, the server arrangement comprising:
an identifying element for identifying a deterioration in a connectivity or reachability between the server and the at least one client and/or application, and
a transmitting element for transmitting a re-establishment message to the at least one client and/or application, the re-establishment message making or enabling the at least one client and/or application re-establish the connectivity or reachability.

11. The server arrangement of claim 10, wherein the connectivity or reachability is established via or through a pinhole in a firewall.

12. The server arrangement of claim 11, wherein the deterioration is a termination of an open state of the pinhole.

13. The server arrangement of claim 10, wherein the identifying element is adapted to identify an interruption in the connectivity or reachability.

14. The server arrangement of claim 10, wherein the transmitting element is adapted to transmit the re-establishment message from the server to the at least one client and/or application.

15. The server arrangement of claim 10, wherein the transmitting element is adapted to transmit a re-establishment message that makes or enables at least one client and/or application re-establish the connectivity or reachability to a state it had before the deterioration.

16. The server arrangement of claim 10, wherein the arrangement comprises:
an establishing element adapted to establish a connectivity or reachability between at least one client and/or application and the server; and
a registering element for registering, or making available, a terminal address and a client communication port identifier of the at least one client and/or application at or for the server.

17. The server arrangement of claim 10, wherein the registering element is adapted to retrieve or receive the terminal address and the client communication port identifier from the at least one client and/or from a database.

18. The server arrangement of claim 16:
wherein the terminal address is the Mobile Subscriber Integrated Services Digital Network Number of the terminal of the at least one client; and
wherein the client communication port identifier relates to a client communication port being a WAP Push port of the at least one client and/or application.

19. A method, executed in a client and/or application in a communication network, the client and/or application handling connectivity or reachability with or towards at least one server, the method comprising:
establishing connectivity or reachability between the client and/or application and the at least one server; and
transmitting a registration message to the server, the registration message including a client communication port identifier and optionally a terminal address of the client and/or application.

20. The method of claim 19, wherein the connectivity or reachability is established via or through a pinhole in a firewall.

21. The method of claim 19, wherein the deterioration is a termination of an open state of the pinhole.

22. The method of claim 19 comprising receiving, at the client and/or application, a re-establishment message enabling or making the client and/or application to re-establish the connectivity or reachability with or towards the at least one server.

23. The method of claim 19 further comprising receiving, at the client and/or application, the re-establishment message from the at least one server or from an additional server.

24. The method of claim 19 further comprising registering the client and/or application for listening on or to an available communication port of the terminal on which the client and/or application resides, wherein registering the client and/or application for listening possibly precedes establishing connectivity or reachability.

25. The method of claim 19, wherein the client includes a platform, and wherein the platform participated in the establishing, the transmitting, the receiving and the registering.

26. A client arrangement in a terminal in a communication network, the terminal comprising at least one client and being adapted to handle connectivity or reachability with or towards at least one server, the client arrangement comprising:
a client establishing element adapted for establishing connectivity or reachability between a client and/or application and the at least one server, and
a client transmitting element adapted for transmitting a registration message to the at least one server, the registration message including a client communication port identifier and, optionally, a terminal address of the client.

27. The client arrangement of claim 26, wherein the connectivity or reachability is established via or through a pinhole in a firewall.

28. The client arrangement of claim 27, wherein the deterioration is a termination of an open state of the pinhole.

29. The client arrangement of claim 26 further comprising a client receiving element adapted for receiving a re-establishment message enabling or making the client to re-establish the connectivity or reachability with or towards said the at least one server.

30. The client arrangement of claim 26, wherein the client receiving element is adapted to receive the re-establishment message from the at least one server or from an additional server.

31. The client arrangement of claim 26 further comprising a client registering element adapted so that the client and/or application can register itself for listening on or to an available communication port of the terminal on which the client and/or application resides.

32. The client arrangement of claim 26, wherein at least one of the client elements of the client arrangement is included in or on a platform of or in the client.
